(19) United States
(12) Patent Application Publication
(10) Pub. No.: US 2009/0310980 A1
(43) Pub. Date: Dec. 17, 2009

(54) PAPER SHEET CONVEYING APPARATUS AND IMAGE FORMING APPARATUS HAVING SAME

(75) Inventors: Yoshiaki Tashiro, Osaka (JP); Naoki Yamane, Osaka (JP); Hironori Daigo, Osaka (JP)

Correspondence Address: SMITH, GAMBRELL & RUSSELL, 1130 CONNECTICUT AVENUE, N.W., SUITE 1130, WASHINGTON, DC, 20036, US

(73) Assignee: KYOCERA MITA CORPORATION, Osaka (JP)

(21) Appl. No.: 12/480,061

(22) Filed: Jun. 8, 2009

(30) Foreign Application Priority Data
Jun. 12, 2008 (JP) 2008-154191
Jun. 12, 2008 (JP) 2008-154192

(51) Int. Cl. G03G 15/00

(52) U.S. Cl. 399/16

(57) ABSTRACT

A paper sheet conveying apparatus includes: a paper sheet conveying portion that conveys a paper sheet and has an opening; a distance detection portion that projects light to a paper sheet through the opening, receives reflected light from the paper sheet, and detects a distance to the paper sheet; and a cover member that has a light projecting area portion which transmits the projected light therethrough, a light receiving area portion which transmits the reflected light therethrough, and a light block portion which is disposed between the light projecting area portion and the light receiving area portion and blocks flare light reflected by the light projecting area portion, wherein the cover member is disposed at a predetermined distance from a conveying path surface of the paper sheet conveying portion over the same side with respect to the distance detection portion.

This application is based on Japanese Patent Application No. 2008-154191 filed on Jun. 12, 2008, No. 2008-154192 filed on Jun. 12, 2008, the contents of which are hereby incorporated by reference.

### BACKGROUND OF THE INVENTION

1. Field of the Invention

The present invention relates to a paper sheet conveying apparatus that is used for a copying machine, a printer, a facsimile and a multi-function machine of them which use an electrophotographic system and to an image forming apparatus having the paper sheet conveying apparatus, and more particularly, to a paper sheet conveying apparatus for detecting a paper sheet conveying state and to an image forming apparatus having the paper sheet conveying apparatus.

2. Description of Related Art

Conventionally, an image forming apparatus has been known, which includes a photoreceptor for forming a toner image, a transfer belt for transferring the toner image formed on the photoreceptor, a transfer portion for transferring the toner image transferred to the transfer belt to a paper sheet, and a fixing portion for melting and fixing the image transferred to the paper sheet, the image forming apparatus ejects the paper sheet outside the apparatus after fixing.

For example, at the transfer portion and the fixing portion of the foregoing image forming apparatus, the paper sheet conveying speed is controlled at a constant speed. However, if the paper sheet conveying speed at the transfer portion is different from the paper sheet conveying speed at the fixing portion, the paper sheet is tightly stretched or bent between the transfer portion and the fixing portion. In recent years, for size reduction of the apparatus, because the paper sheet conveying path between the transfer portion and the fixing portion is short, if the conveying speed at the fixing portion becomes faster than the conveying speed at the transfer portion, the paper sheet is stretched between the fixing portion and the transfer portion and color deviation of an image is caused; on the other hand, if the conveying speed at the fixing portion becomes slower than the conveying speed at the transfer portion, the paper sheet is bent between the fixing portion and the transfer portion, and it becomes highly possible that a paper jam occurs in the paper sheet conveying path.

In JP-A-1998-97154, a detection sensor that detects a bend of a paper sheet is disposed in the paper sheet conveying path between the transfer portion and the fixing portion; if a paper sheet being conveyed is bent and the bend amount exceeds a predetermined amount, the detection sensor detects the bend, and based on the detection result, the rotation speed that drives a fixing roller is raised, so that the bend amount of the paper sheet is decreased. The detection sensor includes a photo interrupter and an actuator. The actuator is displaced if it comes into contact with the surface of a bent paper sheet and blocks light from the photo interrupter. The detection sensor outputs on/off signals according to the displacement of the actuator.

However, in the foregoing related art, because the detection sensor detects a bend of a paper sheet using physical contact between the actuator and the paper sheet, there is concern that the detection sensor damages the paper sheet when the actuator comes into contact with the paper sheet. Besides, because the surface of the paper sheet to which a toner image is transferred is the surface that comes contact with the actuator, there is concern that the toner image is damaged, which constrains the disposition of the detection sensor that detects a not-printed end portion of the paper sheet in a direction perpendicular to the paper sheet conveying direction so as to avoid damage to the paper sheet.

### SUMMARY OF THE INVENTION

The present invention has been made to deal with the conventional problems, and it is an object of the present invention to provide a paper sheet conveying apparatus that is not constrained in terms of disposition, eliminate possible damage to a paper sheet, and is able to accurately measure a paper sheet conveying state in a wide measurement range.

Also, it is another object of the present invention to provide an image forming apparatus that is able to stably measure a paper sheet conveying state irrespective of temperature change and time-dependent change.

To achieve the foregoing object, the present invention includes: a paper sheet conveying portion that conveys a paper sheet and has an opening; a distance detection portion that projects light to a paper sheet through the opening, receives reflected light from the paper sheet, and detects a distance to the paper sheet; and a cover member that has a light projecting area portion which transmits the projected light therethrough, a light receiving area portion which transmits the reflected light therethrough, and a light block portion which is disposed between the light projecting area portion and the light receiving area portion and blocks flare light reflected by the light projecting area portion, wherein the cover member is disposed at a predetermined distance from a conveying path surface of the paper sheet conveying portion over the same side with respect to the distance detection portion.

According to this structure, the projected light from the distance detection portion passes in order through the light projecting area portion of the cover member, the opening of the paper sheet conveying portion, and reaches the paper sheet; the reflected light reflected by the paper sheet passes in order through the opening, the light receiving area portion, and is received by the distance detection portion, so that a distance to the paper sheet is detected based on the reflected light received by the distance detection portion. Thus, a bend amount of the paper sheet is measured without touching the paper sheet, and any portions such as the center portion and end portions of the paper sheet are able to be used as portions to be measured; there is no constraint on the dispositions of the distance detection portion and the like, and the paper sheet and a toner image on the paper sheet are not damaged. Besides, because the light block portion of the cover member prevents flare light, which is part of the projected light and reflected by the light projection area portion, from entering the distance detection portion, so that it is possible to accurately measure the distance. In addition, because the cover member is disposed at a predetermined distance from a conveying path surface of the paper sheet conveying portion over the same side with respect to the distance detection portion, the reflected light from the paper sheet is received by the distance detection portion without being blocked by the light block portion, so that it is possible to detect the paper sheet conveying states such as a bend amount and the like in a wide measurement range.

Also, in the paper sheet conveying apparatus having the above structure according to the present invention, an opposite surface opposite to the conveying path surface of the paper sheet conveying portion is formed flat and the cover member is mounted on the opposite surface.

According to this structure, the cover member is mounted on the opposite surface of the conveying path surface to be disposed at a predetermined distance from the conveying path surface, so that the predetermined distance is able to be easily set.

In the paper sheet conveying apparatus having the above structure according to the present invention, the light block portion is formed of a wall that is treated black.

According to this structure, flare light reflected by the light projecting area portion is prevented by the black-treated wall from passing through the light block portion and entering the distance detection portion, there is no concern over erroneous measurement due to flare light, so that the distance to the paper sheet is accurately measured by using the reflected light from the paper sheet.

In the paper sheet conveying apparatus having the above structure according to the present invention, the distance detection portion is disposed substantially under the paper sheet conveying portion.

According to this structure, there is no concern that foreign matter such as dust and the like that appear at the paper sheet conveying portion drops to the distance detection portion through the opening of the paper sheet conveying portion and causes erroneous measurement, so that the distance to the paper sheet is accurately measured by using the reflected light from the paper sheet.

In the paper sheet conveying apparatus having the above structure according to the present invention, the paper sheet conveying portion and the distance detection portion are disposed in an open/close frame that is able to be freely opened and closed with respect to the apparatus.

According to this structure, even if foreign matter such as dust and the like that appears at the paper sheet conveying portion adheres to the cover member, it is possible to easily remove the foreign matter that adheres to the cover member by opening the open/close frame including the cover member with respect to the apparatus.

In the paper sheet conveying apparatus having the above structure according to the present invention, the cover member is fixed to and held by the paper sheet conveying portion with a cover hold member that pushes circumferential ends of the cover member to the paper sheet conveying portion.

According to this structure, the cover member is surely mounted on the paper sheet conveying portion without blocking the reflected light from a paper sheet and without letting unnecessary light enter the distance detection portion.

In addition, to achieve the above object, the present invention includes: a paper sheet conveying portion that conveys a paper sheet; a distance detection portion that projects light to a conveyed paper sheet, receives reflected light from the paper sheet, and measures a distance to the paper sheet; a storage portion which when the distance detection portion measures a distance to a predetermined position, stores the distance as initial data; a calibration calculation portion which before image formation, calculates calibration data based on first data that are received from the distance detection portion when the distance to the predetermined position is measured and on the initial data received from the storage portion; and a distance calculation portion which in a time of image formation, based on the calibration data, corrects second data that are received from the distance detection portion when the distance to the conveyed paper sheet is measured and calculates a distance.

According to this structure, the projected light from the distance detection portion is reflected by the paper sheet, the reflected light is received by the distance detection portion, and the distance to the paper sheet is detected based on the reflected light received by the distance detection portion. Thus, a bend amount of the paper sheet is measured without touching the paper sheet, and any portions such as the center portion and end portions of the paper sheet are able to be used as portions to be measured ; there is no constraint on dispositions of the distance detection portion and the like, and the paper sheet and a toner image on the paper sheet are not damaged. Besides, the second data for the distance to the paper sheet are corrected based on the calibration data that are calculated by using the initial data in the time of production and shipment and the like and the first data used to measure a distance to the predetermined position immediately before image formation, thereby errors in the measurement at the distance detection portion due to temperature change and time-dependent change are prevented from occurring, so that it is possible to stably measure the paper sheet conveying states irrespective of temperature change and time-dependent change of the distance detection portion.

In the paper sheet conveying apparatus having the above structure according to the present invention, a temperature detection portion that detects temperature inside the apparatus is included, wherein if the temperature detection portion detects a predetermined temperature or higher, the calibration calculation portion sends the calculated calibration data to the distance calculation portion.

According to this structure, if the temperature detection portion detects the predetermined temperature or higher, the distance calculation portion corrects the second data based on the calibration data and calculates a distance. Accordingly, even if the temperature of the distance detection portion becomes a high temperature because of development or fixing in the time of image formation, it is possible to prevent fluctuation from occurring in the measurement at the distance detection portion.

In the paper sheet conveying apparatus having the above structure according to the present invention, a sheet number count portion that counts the number of printed paper sheets is included, wherein if the sheet number count portion counts a predetermined number of printed paper sheets, the calibration calculation portion sends the calculated calibration data to the distance calculation portion.

According to this structure, if the sheet number count portion counts the predetermined number of printed paper sheets, the distance calculation portion corrects the second data based on the calibration data and calculates a distance. Accordingly, even if the number of printed paper sheets increases and the light amount from a light emitting portion decreases because of time-dependent change of the distance detection portion, it is possible to prevent fluctuation due to the decrease in the light amount from the distance detection portion from occurring in the measurement at the distance detection portion.

In the paper sheet conveying apparatus having the above structure according to the present invention, the storage portion stores a job that is set and executed; if the storage portion stores a job for using a plurality of paper sheets for successive printing, the calibration calculation portion sends the calculated calibration data to the distance calculation portion for every predetermined number of paper sheets in the job.

According to this structure, the storage portion stores the job for using a plurality of paper sheets for successive printing, and the distance calculation portion corrects the second data based on the calibration data and calculates a distance for every predetermined number of paper sheets in the job. Accordingly, even if the number of printed paper sheets increases and the light amount from the light emitting portion decreases because of time-dependent change of the distance detection portion, it is possible to prevent fluctuation due to the decrease in the light amount from the distance detection portion from occurring in the measurement at the distance detection portion.

In the paper sheet conveying apparatus having the above structure according to the present invention, the distance detection portion projects light to a paper sheet through an opening formed through a portion of the paper sheet conveying portion and receives reflected light from the paper sheet; and a calibration surface that faces the paper sheet conveying path surface of the paper sheet conveying portion is disposed at the predetermined position.

According to this structure, the projected light from the distance detection portion passes through the opening of the paper sheet conveying portion, and reaches the paper sheet or the calibration surface; the reflected light reflected by the conveyed paper sheet or the calibration surface passes through the opening and is received by the distance detection portion. Accordingly, the calibration surface is able to be easily formed and set by using a constituent member of the apparatus without using a special member. Besides, it is possible to set the calibration surface without disturbing the measurement of the distance to the conveyed paper sheet.

In the paper sheet conveying apparatus having the above structure according to the present invention, the calibration surface has the substantially same reflectance as that of the paper sheet to be measured.

According to this structure, it is possible to accurately carry out the calibration based on data of the calibration surface measured by the distance detection portion.

In the paper sheet conveying apparatus having the structure according to the present invention, the calibration surface is formed on a plate member that is attached to a member that constitutes the apparatus.

According to this structure, it is possible to easily mount the calibration surface on the constituent member.

Besides, the present invention is an image forming apparatus in which the paper sheet conveying portion includes a paper sheet conveying apparatus having the above structure that conveys a paper sheet between a transfer portion that transfers a toner image formed on a photoreceptor to the paper sheet and a fixing portion that melts and fixes the toner image transferred to the paper sheet.

According to this structure, the distance detection portion is able to detect the distance to the paper sheet at the position of the paper sheet conveying portion between the transfer portion and the fixing portion and measure accurately a bend amount of the paper sheet in a wide measurement range. Besides, it is possible to perform stable measurement irrespective of temperature change and time-dependent change.

### BRIEF DESCRIPTION OF THE DRAWINGS

FIG. 1 is a sectional view showing a schematic structure of an image forming apparatus according to a first embodiment of the present invention.

FIG. 2 is a sectional view showing a paper sheet conveying path between a transfer portion and a fixing portion of the image forming apparatus according to the first embodiment of the present invention.

FIG. 3 is a perspective view showing the paper sheet conveying path between the transfer portion and the fixing portion of the image forming apparatus according to the first embodiment of the present invention.

FIG. 4 is a schematic side sectional view showing a detection state of a distance to a paper sheet performed by a distance detection portion of the image forming apparatus according to the first embodiment of the present invention.

FIG. 5 is a sectional side view showing the distance detection potion and a cover member in the paper sheet conveying path between the transfer portion and the fixing portion of the image forming apparatus according to the first embodiment of the present invention.

FIG. 6 is a sectional view showing a calibration plate disposed near the paper sheet conveying path between the transfer portion and the fixing portion of the image forming apparatus according to the first embodiment of the present invention.

FIG. 7 is a sectional side view showing the distance detection portion near the paper sheet conveying path between the transfer portion and the fixing portion of the image forming apparatus according to the first embodiment of the present invention.

FIG. 8 is a block diagram showing a structure of the image forming apparatus according to the first embodiment of the present invention.

FIG. 9 is a view showing a relationship between distance and sensor output from the distance detection portion of the image forming apparatus according to the first embodiment of the present invention.

FIG. 10 is a view showing a relationship between temperature and sensor output from the distance detection portion of the image forming apparatus according to the first embodiment of the present invention.

FIG. 11 is a block diagram showing a structure of an image forming apparatus according to a second embodiment of the present invention.

### DETAILED DESCRIPTION OF PREFERRED EMBODIMENTS

Hereinafter, embodiments of the present invention are described with reference to drawings. However, the present invention is not limited to the embodiments. The embodiments of the present invention represent the most preferred embodiments of the present invention, and the applications of the present invention and the technical terms and the like are not limited to those described here.

### First Embodiment

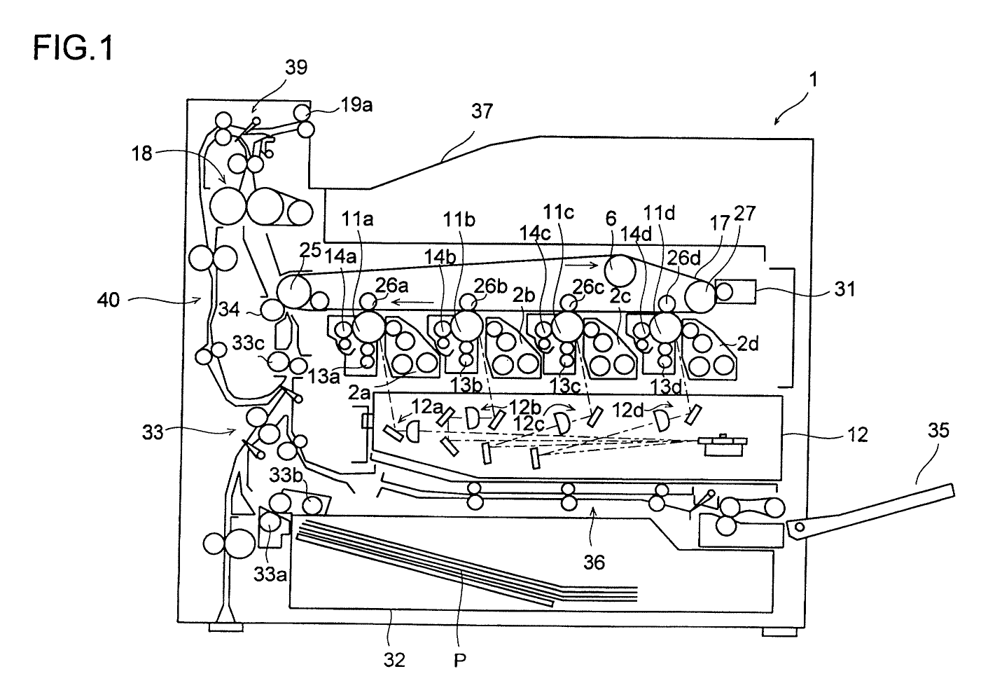

FIG. 1 is a sectional plan view showing schematically innards of an image forming apparatus according to a first embodiment of the present invention. An image forming apparatus 1 is a tandem-type color printer. Rotatable photoreceptors 11a to 11d are organic photoreceptors (OPC photoreceptors) that use a photosensitive material to form a photosensitive layer, and disposed respectively corresponding to colors of black (B), yellow (Y), cyan (C) and magenta (M). The photosensitive layer may be formed of amorphous silicon. Development devices 2a to 2d, an exposure unit 12, electrifiers 13a to 13d, and electricity removers 14a to 14d are disposed around each of the photoreceptors 11a to 11d, respectively.

The development devices 2a to 2d are disposed to face the right sides of the photoreceptors 11a to 11d respectively, and supply toners to the photoreceptors 11a to 11d. The electrifiers 13a to 13d are disposed to face the surfaces of the photoreceptors 11a to 11d respectively on the upstream sides in rotation directions of the photoreceptors 11a to 11d with respect to the development devices 2a to 2d, and electrify evenly the surfaces of the photoreceptors 11a to 11d. The electricity removers 14a to 14d are disposed to face the surfaces of the photoreceptors 11a to 11d respectively on the downstream sides in the rotation directions of the photoreceptors 11a to 11d with respect to the development devices 2a to 2d, and remove the electric charges remaining on the surfaces of the photoreceptors 11a to 11d after development.

The exposure unit 12 scans each of the photoreceptors 11a to 11d for exposure based on image data such as letters and icons that are input into an image input portion (not shown) from a personal computer or the like, and disposed under the development devices 2a to 2d respectively. The exposure unit 12 is equipped with a laser light source and a polygonal mirror, and also with a reflection mirror and a lens that correspond to each of the photoreceptors 11a to 11d. Laser light emitted from the laser light source is directed from the downstream sides in the rotation directions of the photoreceptors 11a to 11d with respect to the electrifiers 13a-13d to the surface of each of the photoreceptors 11a to 11d via the polygonal mirror, the reflection mirrors, and the lenses. An electrostatic latent image is formed on the surface of each of the photoreceptors 11a to 11d by the directed laser light, and the electrostatic latent image is developed into a toner image by each of the development devices 2a to 2d.

An intermediate transfer belt 17 is mounted on a tension roller 6, a drive roller 25 and a driven roller 27. The photoreceptors 11a to 11d are disposed next to each other along the conveying direction (the arrow direction in FIG. 1) under the intermediate transfer belt 17 so as to come into contact with the intermediate transfer belt 17. Each of the primary transfer rollers 26a to 26d faces each of the photoreceptors 11a to 11d with the intermediate transfer belt 17 sandwiched therebetween and comes into tight contact with the intermediate transfer belt 17 so as to form a primary transfer nip portion. At the first transfer nip portion, the toner image on each of the photoreceptors 11a to 11d is successively transferred to the intermediate transfer belt 17 as the intermediate transfer belt 17 rotates, so that the four color images of cyan, magenta, yellow and black are overlapped so as to form a full-color toner image on the surface of the intermediate transfer belt 17.

A secondary transfer roller 34 faces the drive roller 25 with the intermediate transfer belt 17 sandwiched therebetween and comes into tight contact with the intermediate transfer belt 17 so as to form a secondary transfer nip portion (a transfer portion). At the secondary transfer nip portion, the toner image on the surface of the intermediate transfer belt 17 is transferred to the paper sheep P. After the transfer, a belt cleaner 31 removes the toner remaining on the surface of the intermediate transfer belt 17.

A paper sheet supply cassette 32 that stores the paper sheets P is disposed in a lower portion of the image forming apparatus 1, and a stack tray 35 that supplies paper sheets which are manually set is disposed to the right of the paper sheet supply cassette 32. A first conveying path 33 that conveys the paper sheet P sent out of the paper sheet supply cassette 32 to the secondary transfer nip portion of the intermediate transfer belt 17 is disposed to the left of the paper sheet supply cassette 32. Besides, a second conveying path 36 that conveys the paper sheet P sent out of the stack tray 35 to the secondary transfer nip portion is disposed to the left of the stack tray 35. In a left upper portion of the image forming apparatus 1, a fixing portion 18 that applies fixing treatment to the paper sheet P on which an image is formed and a third conveying path 39 that conveys the paper sheet P which has undergone the fixing treatment to a paper sheet ejection portion 37 are disposed.

The paper sheet supply cassette 32 is able to be pulled outside (toward a point over the paper surface of FIG. 1) the apparatus 1, so that it is possible to supply paper sheets. The paper sheets P stored are sent out to the first conveying path 33 one after another by a pickup roller 33b and a separation roller 33a.

The first conveying path 33 and the second conveying path 36 join each other before a resist roller 33c. In response to the timings of image-forming operation and paper sheet supply operation at the intermediate transfer belt 17, the resist roller 33c conveys the paper sheet P to the secondary transfer nip portion. The paper sheet P is conveyed to the second nip portion, where the full-color toner image on the intermediate transfer belt 17 is secondarily transferred to the paper sheet P by the secondary transfer roller 34 to which a bias potential (which has polarity opposite to the electrified polarity of the toner), then the paper sheet P is conveyed to the fixing portion 18.

The fixing portion 18 includes a fixing belt that is heated by a heater, a fixing roller, and a pressurization roller that is disposed to be pressurized to the fixing roller, and the fixing portion 18 performs fixing treatment by heating and pressurizing the paper sheet P to which the toner image is transferred. After the toner image is fixed on the paper sheet P at the fixing portion 18, the paper sheet P is turned upside down in a fourth conveying path 40 if necessary, a toner image is secondarily transferred to the back surface of the paper sheet P and is fixed at the fixing portion 18. The paper sheet P on which the toner image is fixed is ejected through the third conveying path 39 to the paper sheet ejection portion 37 by an ejection roller 19a.

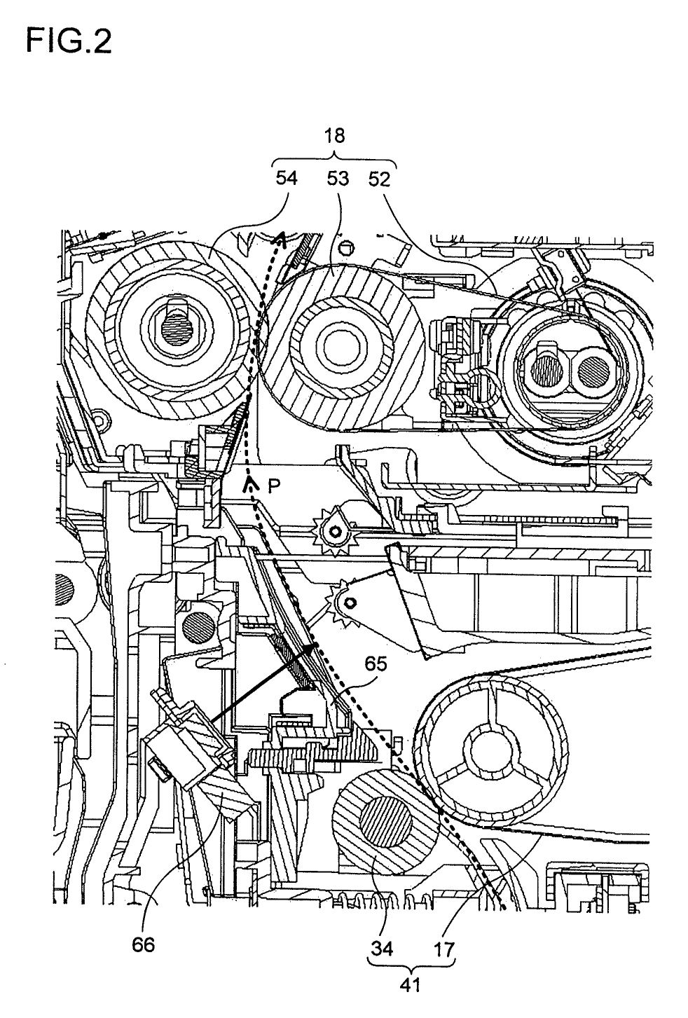

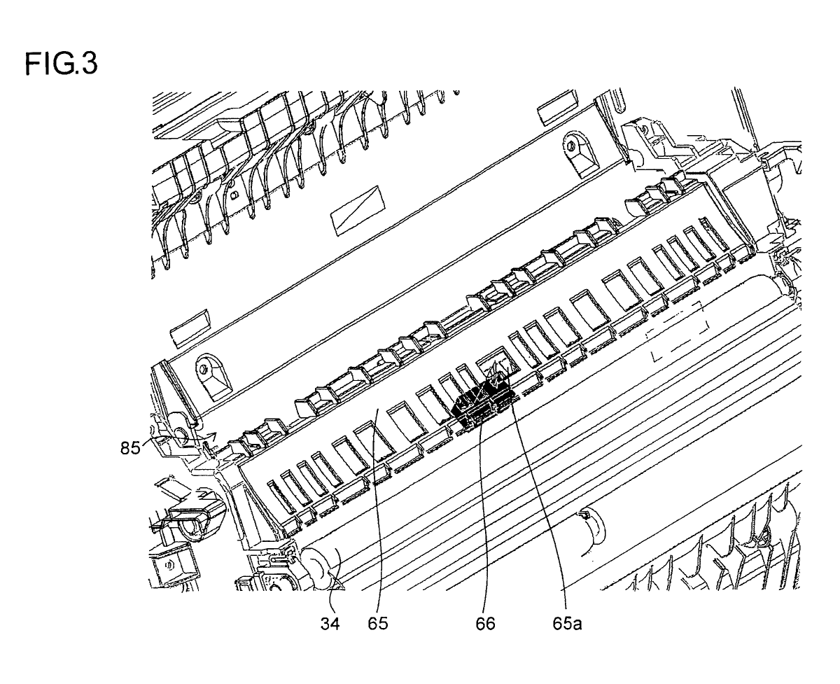

Based on FIGS. 2 and 3, an arrangement structure of a paper sheet conveying portion and a distance detection portion as a paper sheet conveying apparatus between the transfer portion (the secondary transfer nit portion) and the fixing portion is explained. FIG. 2 is a sectional view showing a paper sheet conveying portion and a distance detection portion according to an embodiment of the present invention. FIG. 3 is a perspective view showing the paper sheet conveying portion and the distance detection portion, and shows a state in which the paper sheet conveying path is opened to the outside of the apparatus.

As shown in FIG. 2, a transfer portion 41 includes the intermediate transfer belt 17 and the secondary transfer roller 34, and the fixing portion 18 includes a fixing belt 52, a fixing roller 53 that is heated by the fixing belt 52, and a pressurization roller 54. The fixing portion 18 is disposed at a position left above the transfer portion 41, and a paper sheet conveying portion 65 that guides transportation of the paper sheet P conveyed in the broken-line direction shown in FIG. 2 is disposed between the transfer portion 41 and the fixing portion 18.

The paper sheet conveying portion 65 extends left upward between a position above the transfer portion 41 and a position below the fixing portion 18, and the conveying path surface for guiding transportation of the paper sheet P is formed on the surface side. The distance detection portion 66 is disposed at a distance away from the paper sheet conveying portion 65 behind the surface (opposite surface) opposite to the conveying path surface of the paper sheet conveying portion 65. The distance detection portion 66 described later in detail has surfaces which are used to project and receive light and face the paper sheet conveying portion 65, and projects light in the solid-line arrow direction shown in FIG. 2.

As shown in FIG. 3, the paper sheet conveying portion 65 is disposed along the longitudinal direction of the secondary transfer roller 34 and includes a rectangular opening 65a through a substantially central portion in the longitudinal direction. The opening 65a is formed through a position through which light is projected and received from and by the distance detection portion 66 that is disposed behind the paper sheet conveying portion 65.

The paper sheet conveying portion 65 and the distance detection portion 66 are arranged in an open/close frame 85. The open/close frame 85 is a component that constitutes a side wall of the image forming apparatus 1 and is able to open the inside of the apparatus when a paper jam in the conveying path is resolved. Accordingly, the open/close frame 85 is pivotally supported (not shown) so as to be rotatable with respect to the apparatus, so that if the open/close frame 85 is rotated about the pivotal shaft, the state between the apparatus and the open/close frame 85 is changed between an open state (the state shown in FIG. 3) in which the open/close frame 85 is opened from the apparatus and a closed state in which image formation is possible.

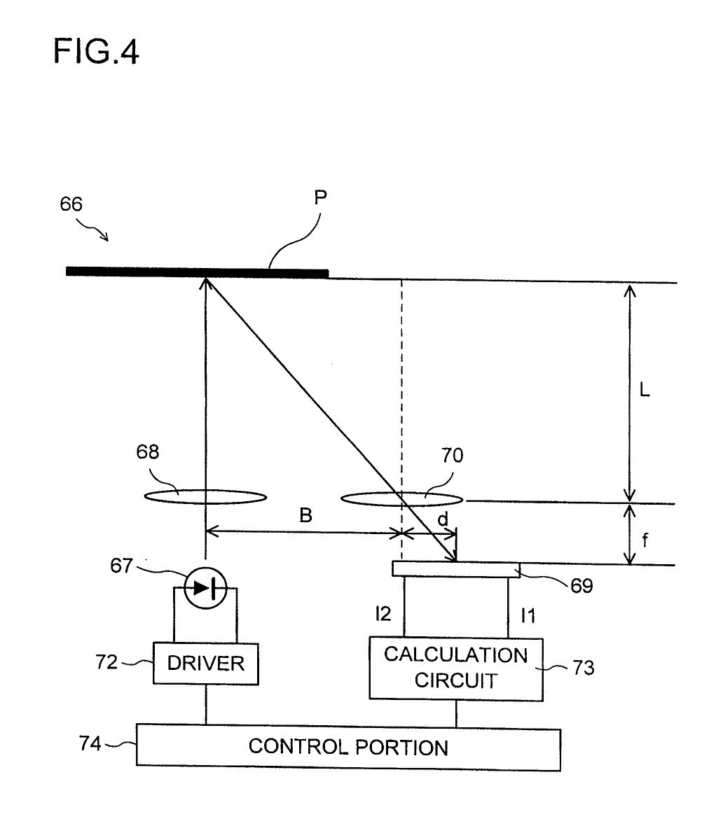

Based on FIG. 4, the distance detection portion 66 is described in detail. FIG. 4 is a side view showing a schematic structure of the distance detection portion 66 according to the embodiment of the present invention.

The distance detection portion 66 includes a light projector that has a light source 67 and a light projecting lens 68; and a light receiver that has a PSD (Position Sensitive Detector) device 69 and a light receiving lens 70; and further includes a driver circuit 72 that drives the light source 67; and a calculation circuit 73 that calculates the gravity-center position of the light amount of reflected light on the PSD device 69. The driver circuit 72 and the calculation circuit 7 are controlled by a control portion 74.

The light projector and the light receiver are arranged along the longitudinal direction of the secondary transfer roller 34 (see FIG. 3). In the light projector, the light source 67 that includes a infrared-light emitting diode is driven by the driver circuit 72; the emitted light is condensed by the light projecting lens 68 and projected onto the paper sheet P. In the light receiver, the reflected light from the paper sheet P is condensed by the light receiving lens 70 and enters the PSD device 69.

The PSD device 69 converts the reflected light from the paper sheet P into an electric current proportionate to the light intensity, and divides the current into two current signals I1 and I2 at the ratio depending on an incident position d. The output currents I1, I2 are amplified and input into the calculation circuit 73. Based on a current ratio between the output currents I1 and I2, the calculation circuit 73 calculates the incident position d that corresponds to the gravity-center position of the amount of the reflected light on the PDS device 69.

Based on the incident position d output from the calculation circuit 73 and optical constants of the light projector and the light receiver, the control portion 74 calculates the distance to the paper sheet P. Specifically, as shown in FIG. 4, if the distance from the light receiving lens 70 to the paper sheet P is L, the focal length of the light receiving lens 70 is f, and the distance between the optical axes of the light receiving lens 70 and the light projecting lens 68 is B, the relationship between the distance L and the incident position d is as follows:

L=Bf/d formula (1)

The control portion 74 calculates the distance L to the paper sheet P according to the incident position d from the formula (1).

Besides, the control portion 74 checks for a bend of the paper sheet P based on the calculated distance L, and if there is a bend, controls and corrects the rotation speeds of the rollers of the transfer portion 41 and the fixing portion 18 based on the bend amount in order to prevent the paper sheet P from bending at the paper sheet conveying portion 65.

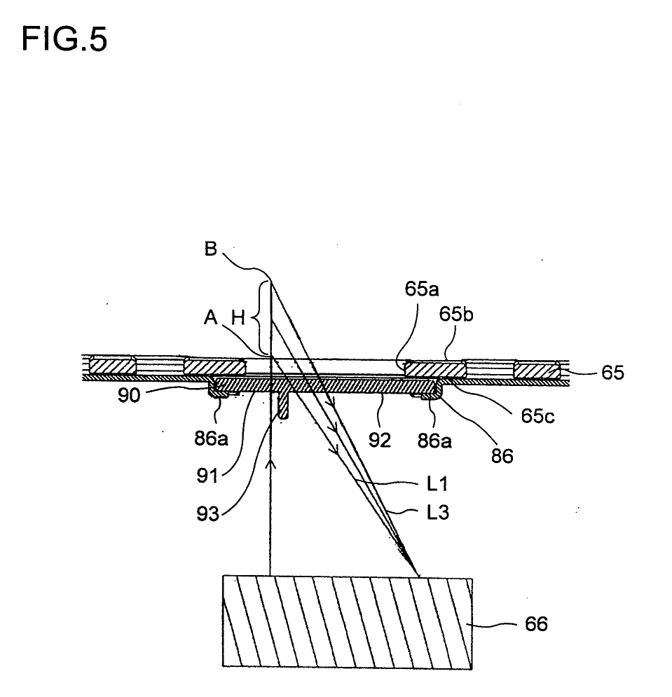

Next, based on FIG. 5, a cover member 90 disposed near the opening 65a of the paper sheet conveying portion 65 is explained. FIG. 5 is a sectional side view showing a cover member according to an embodiment of the present invention.

The paper sheet conveying portion 65 includes a conveying path surface 65b for conveying the paper sheets P and an opposite surface 65c that is opposite to the conveying path surface 65b and faces the distance detection portion 66, and the paper sheet conveying portion 65 forms the opening 65a between the conveying path surface 65b and the opposite surface 65c.

The cover member 90 is made of a light-transmissive material such as an acrylic resin and the like and is formed into a substantially rectangular-shaped flat plate that has a larger size than the opening 65a, and on the surface (the back surface) that faces the distance detection portion 66, includes a light block portion 93 that protrudes toward the distance detection portion 66. The opposite surface 65c of the paper sheet conveying portion 65 is formed of a flat surface, and on the opposite surface 65c, the cover member 90 is fixed and held by a cover hold member 86. The cover hold member 86 includes at least three push portions 86a; circumferential end portions of the cover member 90 are pushed to the opposite surface 65c by the push portions 86a, fixed to the paper sheet conveying portion 65 by bonding, screws or the like.

On the back surface of the cover member 90, the cover member 90 includes a light projecting area portion 91 to the left of the light block portion 93, and a light receiving area portion 92 to the right of the light block portion 93. The light projecting area portion 91 faces the light projector of the distance detection portion 66 and transmits the light projected to the paper sheet P therethrough; the light receiving area portion 92 faces the light receiver of the distance detection portion 66 and transmits the reflected light from the paper sheet P therethrough.

Here, to detect the bend amount of the paper sheet P, if a range necessary for the distance detection is a section H from a point A on the conveying path surface 65b to a point B, the distance detection portion 66 needs only to receive light of the reflected light from the paper sheet P which is present in a range from the light L1 to the light L3.

Accordingly, the light block portion 93 is formed as an upright wall perpendicular to the conveying path surface 65b at a position where the light block portion 93 does not block the light L1. Because the surface of the upright wall of the light block portion 93 near the light projection area surface 91 is coated with a black paint, even if light projected from the light projection portion 66 is reflected by the light projecting area portion 91, the reflected light (flare light) is blocked by the surface that is treated black, so that there is no concern that the reflected light enters the light receiver of the distance detection portion 66 through the light block portion 93. The light block portion 93 may be formed of a member that is coated black or may be formed by attaching a separate resin member that is mixed with black coloring matter to the flat cover member 90 that is light-transmissive. Besides, another structure may be employed, in which the cover member 90 includes: a flat plate portion that has the light projecting area portion 91 and the light receiving area portion 92 both of which are formed of a light-transmissive material; and the light block portion 93 that is formed unitarily with the flat plate portion; the surface of the light block portion 93 is formed into a rough surface that has minute concave and convex portions; the flare light reflected by the light projecting area portion 91 is scattered by the rough surface, so that the flare light is prevented from reaching the light receiver through the light block portion 93. In addition, instead of the rectangular sectional shape, the light block portion 93 may have a triangular shape in section, a trapezoidal shape in section, or any other shapes that prevent the flare light that appear at the light projecting area portion 91 from reaching the light receiver through the light block portion 93.

The push portion 86a of the cover hold member 86 may be extended almost to a position on the light receiving area portion 92 where the light L3 passes through the light receiving area portion 92, so that light other than the reflected light from the paper sheet P is prevented from entering the light receiver of the distance detection portion 66. Thus, because unnecessary light does not enter the light receiver of the distance detection portion 66, accuracy of the distance detection further increases.

According to the embodiment above, the paper sheet conveying apparatus includes: the paper sheet conveying portion 65 that caries the paper sheet P and has the opening 65a; the distance detection portion 66 that projects the light through the opening 65a to the paper sheet P, receives the reflected light from the paper sheet P and detects the distance to the paper sheet P; and the cover member 90 that has: the light projecting area portion 91 that transmits the projected light therethrough, the light receiving area portion 92 that transmits the reflected light therethrough, and the light block portion 93 that is disposed between the light projecting area portion 91 and the light receiving area portion 92 and blocks the flare light that is reflected by the light projecting area portion 91, wherein the cover member 90 is disposed at the predetermined distance (the distance between the conveying path surface 65b and the opposite surface 65c) from the conveying path surface 65b of the paper sheet conveying portion 65 over the same surface with respect to the distance detection portion 66.

According to this structure, the projected light from the distance detection portion 66 passes in order through the light projecting area portion 91 of the cover member 90, the opening 65a of the paper sheet conveying portion 65, and reaches the paper sheet P; the reflected light reflected by the paper sheet P passes in order through the opening 65a, the light receiving area portion 92, and is received by the distance detection portion 66, so that the distance to the paper sheet P is detected based on the reflected light received by the distance detection portion 66. Thus, the bend amount of the paper sheet P is measured without touching the paper sheet P, and any portions such as the center portion and end portions of the paper sheet P are able to be used as portions to be measured; accordingly, there is no constraint on dispositions of the distance detection portion 66 and the like, and the paper sheet P and a toner image on the paper sheet P are not damaged. Besides, because the light block portion 93 of the cover member 90 prevents the flare light, which is part of the projected light and reflected by the light projecting area portion 91, from entering the distance detection portion 66, so that it is possible to accurately measure the distance. In addition, because the cover member 90 is disposed at the predetermined distance from the conveying path surface 65b of the paper sheet conveying portion 65 over the same side with respect to the distance detection portion 66, the reflected light from the paper sheet P is received by the distance detection portion 66 without being blocked by the light block portion 93, so that it is possible to detect paper sheet conveying states such as a bend amount and the like in a wide measurement range.

Besides, according to the embodiment above, the opposite surface 65c opposite to the conveying path surface 65b of the paper sheet conveying portion 65 is formed flat and the cover member 90 is mounted on the opposite surface 65c to be disposed at a predetermined distance from the conveying path surface 65b, so that the predetermined distance is able to be easily set.

According the embodiment above, the light block portion 93 is disposed perpendicularly to the conveying path surface 65b and is formed of the wall that is treated black (the black-treated wall). Because the flare light reflected by the light projecting area portion 91 is prevented by the black-treated wall from passing through the light block portion 93 and entering the distance detection portion 66, there is no concern over erroneous measurement due to the flare light, so that the distance to the paper sheet P is accurately measured by using the reflected light from the paper sheet P.

According to the embodiment above, although the distance detection portion 66 is disposed substantially under the paper sheet conveying portion 65, there is no concern that foreign matter such as dust and the like that appears at the paper sheet conveying portion 65 drops to the distance detection portion 66 through the opening 65a of the paper sheet conveying portion 65 and causes erroneous measurement. Accordingly, it is possible to accurately measure the distance to the paper sheet P by using the reflected light from the paper sheet P.

According to the embodiment above, the paper sheet conveying portion 65 and the distance detection portion 66 are disposed in the open/close frame 85 that is able to be freely opened and closed with respect to the apparatus. Accordingly, even if foreign matter such as dust and the like that appears at the paper sheet conveying portion 65 adheres to the cover member 90, it is possible to easily remove the foreign matter that adheres to the cover member 90 by opening the open/close frame 85 including the cover member 90 with respect to the apparatus.

According to the embodiment above, the paper sheet conveying portion 65 conveys the paper sheet P between the transfer portion 41 that transfers a toner image formed on a photoreceptor to the paper sheet P and the fixing portion 18 that melts and fixes the toner image transferred to the paper sheet. Accordingly, the distance detection portion 66 is able to detect the distance to the paper sheet P at the position of the paper sheet conveying portion 65 between the transfer portion 41 and the fixing portion 18 and measure accurately the bend amount of the paper sheet P in a wide measurement range.

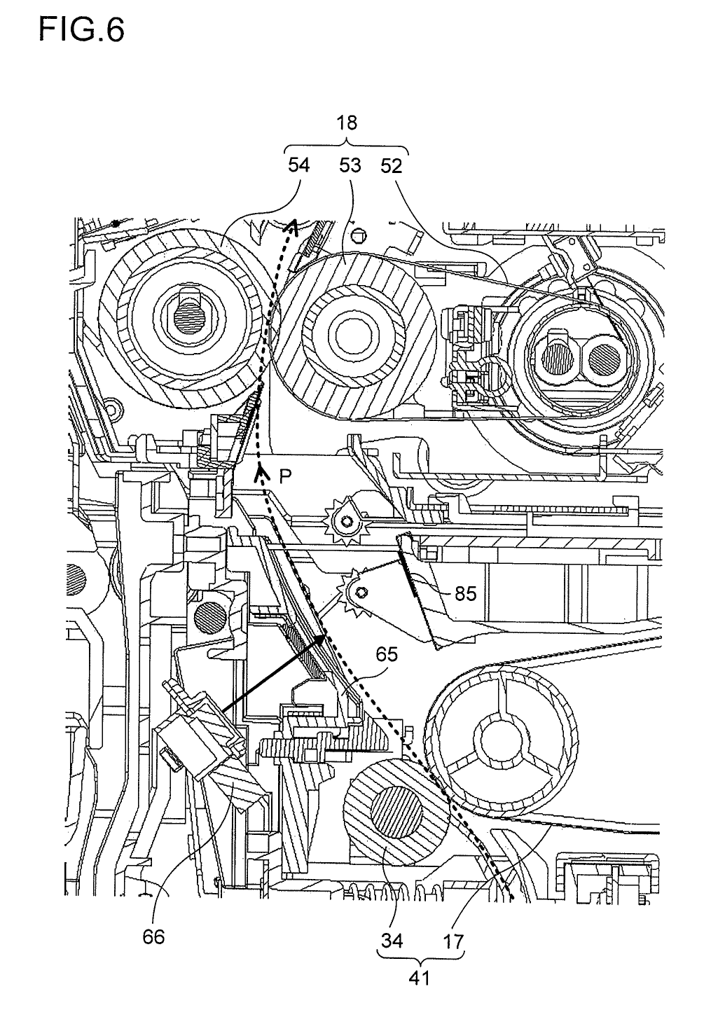

Next, calibration of the distance detection portion 66 for stable measurement of the paper sheet conveying states irrespective of temperature change and time-dependent change is explained. FIG. 6 is a sectional view showing the paper sheet conveying portion and the distance detection portion that is calibrated. The structures of the image forming apparatus 1, the paper sheet conveying portion 65 and the cover member 90, the paper sheet conveying direction, and the arrangement of the distance detection portion 66 with respect to the paper sheet conveying portion 65 are the same as those shown in FIGS. 1 to 3.

The paper sheet conveying portion 65 extends left upward between a position above the transfer portion 41 and a position below the fixing portion 18, and the conveying path surface for guiding transportation of the paper sheet P is formed on the surface side. The distance detection portion 66 is disposed at a distance away from the paper sheet conveying portion 65 behind the opposite surface opposite to the conveying path surface of the paper sheet conveying portion 65. The distance detection portion 66 projects light in the solid-line arrow direction shown in FIG. 6.

A calibration plate 85 is disposed to face the conveying path surface of the paper sheet conveying portion 65. The calibration plate 85 is used to correct fluctuation in the measured data due to change in the ambient temperature around the distance detection portion 66, and the surface of the calibration plate 85 is so treated as to have the substantially same reflectance as that of the paper sheet P. The calibration plate 85 is attached to a constituent member of the image forming apparatus I which is disposed at a position that is farther than the conveying path surface and a predetermined distance away from the distance detection portion 66. The projected light from the distance detection portion 66 is reflected by the surface of the calibration plate 85, the reflected light is received by the distance detection portion 66, and fluctuation in the measured data is corrected based on the received light.

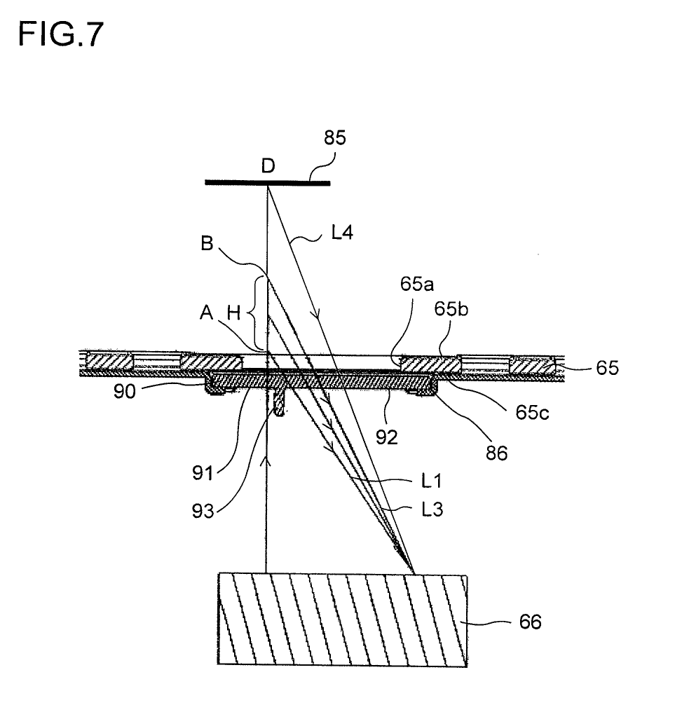

FIG. 7 is a sectional side view showing the calibration plate and important portions of the paper sheet conveying portion and the distance detection portion.

As shown in FIG. 7, the paper sheet conveying portion 65 includes the conveying path surface 65b for conveying the paper sheets P and the opposite surface 65c that is opposite to the conveying path surface 65b and faces the distance detection portion 66, and the paper sheet conveying portion 65 forms the opening 65a between the conveying path surface 65b and the opposite surface 65c.

The cover member 90 is made of a light-transmissive material such as an acrylic resin and the like and is formed into a substantially rectangular-shaped flat plate that has a larger size than the opening 65a, and on the surface (the back surface) that faces the distance detection portion 66, includes the light block portion 93 that protrudes toward the distance detection portion 66, and is fixed and held by the cover hold member 86 on the opposite surface 65c of the paper sheet conveying portion 65. On the back surface of the cover member 90, the cover member 90 includes the light projecting area portion 91 to the left of the light block portion 93, and the light receiving area portion 92 to the right of the light block portion 93. The light projecting area portion 91 transmits the light projected to the paper sheet P and the calibration plate 85 therethrough, and the light receiving area portion 92 transmits the reflected light from the paper sheet P and the calibration plate 85 therethrough.

To detect the bend amount of the paper sheet P, the distance detection portion 66 receives light which is present in the range from the light L1 to the light L3 reflected from the paper sheet P in the section H from the point A on the conveying path surface 65b to the point B. Besides, to calibrate the measured data on the conveyed paper sheet, the distance detection portion 66 receives light L4 reflected at a point D of the calibration plate 85 that is located at a predetermined distance from the distance detection portion 66.

Like the distance measurement in the time of conveying the paper sheet shown in FIG. 4, the predetermined distance to the calibration plate 85 is measured based on the reflected light that is reflected from the calibration plate 85 and is received by the distance detection portion 66, and calibration data are prepared based on the measurement result.

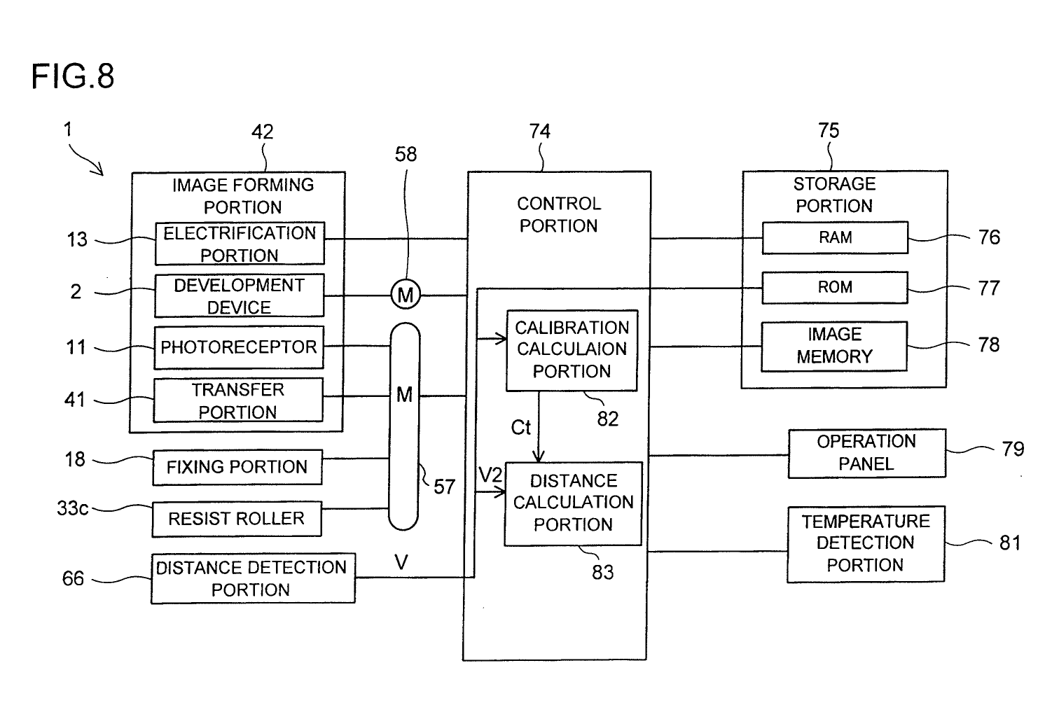

Next, distance calculation by the control portion and calibration of the measured data are explained based on FIG. 8. FIG. 8 is a block diagram showing a structure of the image forming apparatus that includes the control portion.

The image forming apparatus 1 includes: the image forming portion 42 that has the electrification portion 13, the development device 2, the photoreceptor 11 and the transfer portion 41; a drive means 57 that drives the photoreceptor 11, the transfer portion 41 and the fixing portion 18; a drive means 58 that drives the development device 2; a temperature detection portion 81 that detects the temperature inside the image forming apparatus 1; the control portion 74; a storage portion 75; and an operation panel 79.

The operation panel 79 is composed of an operation portion that has a plurality of operation keys and a display portion that displays setting conditions, a state of the apparatus (both of them are not shown) and the like. The operation panel 79 is used when a user turns on and off the power supply of the apparatus and sets a job for printing conditions and the like such as the sizes and kinds of paper sheet and the number of paper sheets to be printed. In a case where the image forming apparatus 1 has a facsimile function, the operation panel 79 is used for various settings such as registrations of facsimile destinations into the storage portion 75, reading and rewriting the registered destinations and the like.

The storage portion 75 include a RAM 76, a ROM 77 and an image memory 78. The RAM 76 and the ROM 77 store processing programs, processed contents and the like of the control portion 75, and the image memory 78 stores image data such as letters and icons that are input into an image input portion from a personal computer and the like.

Generally, for every image forming apparatus 1 or every production lot, there is unevenness in dimension and characteristic of constituent members of the apparatus. Besides, positional errors appear among constituent members in the time of assembly. Also, in the distance detection potion 66 and the calibration plate 85 (see FIG. 6), there is an error in the predetermined distance from the distance detection portion 66 to the calibration plate 85 due to these positional errors among the constituent members, and there is unevenness in the characteristics of the distance detection portion 66. Accordingly, it is necessary to perform adjustment for every apparatus or every production lot in the time of production. To adjust the distance detection portion 66, the distance (actual distance) between the distance detection portion 66 and the calibration plate 85 is actually measured with a length measurement device or the like; the calibration plate 85 is measured with the distance detection portion 66; based on the measurement results, that is, sensor outputs from the distance detection portion 66, the adjustment is performed. Specifically, if a sensor output V from the distance detection portion 66 is a voltage V₀, and an actual distance between the distance detection portion 66 and the calibration plate 85 measured by the length measurement device or the like is a distance L₀, there is a relationship between the sensor output V₀ and the actual length L₀ as follows:

L₀=C₀/V₀ formula (2)

The constant C₀ in the formula (2) corresponds to Bf in the above formula (1) L=Bf/d described based on FIG. 4; and the sensor output V₀ corresponds to the incident position d. The constant C₀ is able to be obtained as L₀/V₀ from the formula (2) by using the actual length L₀ and the sensor output V₀. The constant C₀ (=L₀/V₀) not only corresponds to Bf in the formula (1) but also considers both of the unevenness in the characteristic of the distance detection portion 66 for every apparatus or for every production lot and the temperature condition inside the image forming apparatus 1 in the time of production.

The ROM 77 stores the actual length L₀ as the initial data and the constant C₀. A calibration calculation portion described later prepares calibration data by using the following distance calculation formula (3) that is obtained by generalizing the actual length L₀ and the formula (2):

L=C/V formula (3)

The control portion 74 is composed of a microcomputer and the like and performs an overall control of the image forming portion 71, the drive means 57 and 58 according to the outputs from the distance detection portion 66 and the temperature detection portion 81 following the programs set in the RAM 76 and the ROM 77. Besides, the control portion 74 includes a distance calculation portion 83 and a calibration calculation portion 82.

The distance calculation portion 83 calculates the distance to the paper sheet P based on the sensor output signal V input from the distance detection portion 66, the constant C₀ stored in the storage portion 75 and the distance calculation formula L=C/V.

In forming an image, if a signal that indicates a predetermined temperature or higher is input into the control portion 74 from the temperature detection portion 81, the calibration calculation portion 82 prepares calibration data by using the sensor output signal as first data that is obtained in the time of measuring the calibration plate 85 with the distance detection portion 66 and the actual length Lo stored in the storage portion 75, and outputs the calibration data to the distance calculation portion 83.

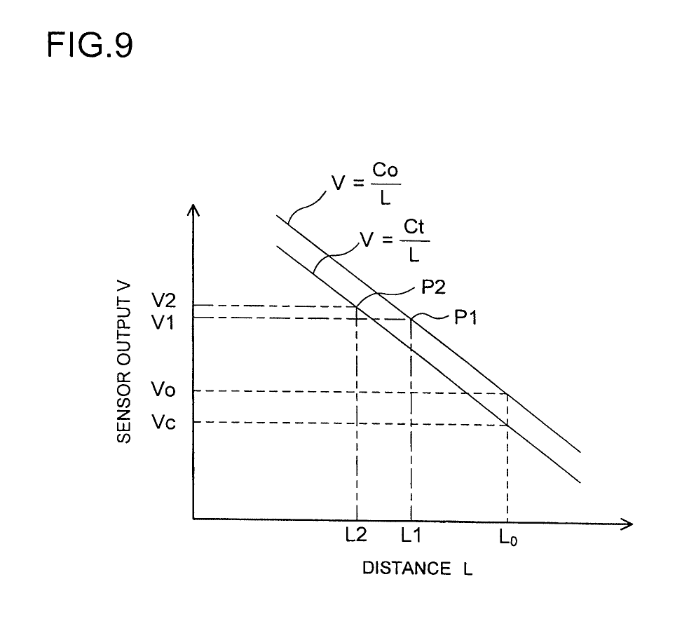

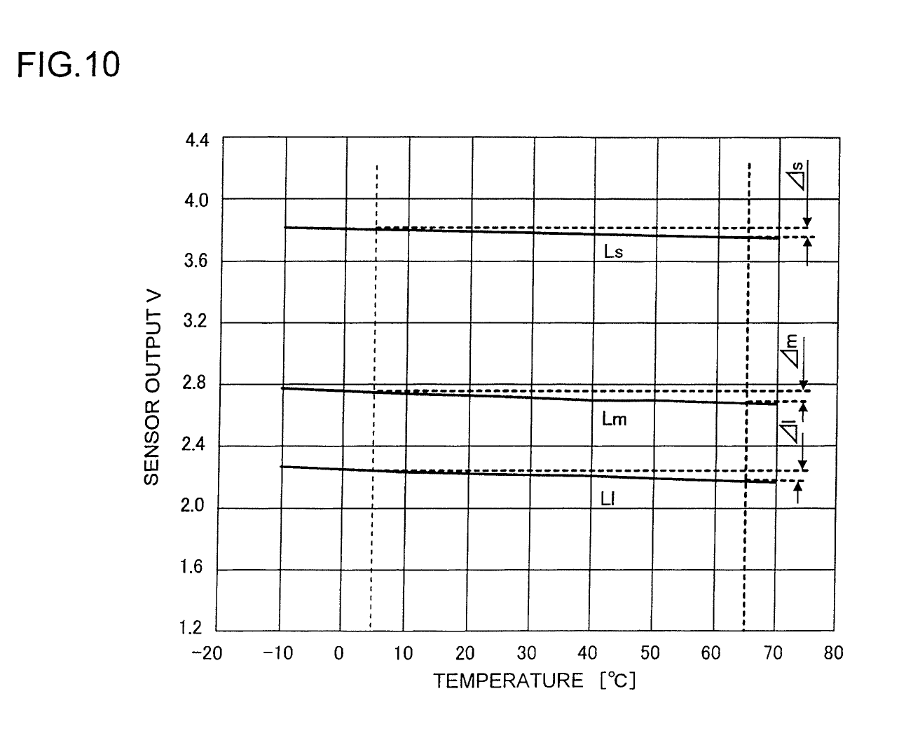

The preparation of the calibration data and the distance calculation are described in detail based on FIGS. 8, 9 and 10. FIG. 9 is a logarithmic graph showing a relationship between the sensor output from the distance detection portion 66 and the calculated distance, in which the horizontal axis represents the distance (L) and the vertical axis represents the sensor output (V) that corresponds to the output voltage from the distance detection portion 66. FIG. 10 is a graph showing a relationship between the sensor output from the distance detection portion 66 and the temperature, in which the horizontal axis represents the temperature (° C.) and the vertical axis represents the sensor output (V) that corresponds to the output voltage from the distance detection portion 66.

During the time the paper sheet P on which an image is formed is conveyed, infrared light is projected to the paper sheet P from the distance detection portion 66, and the distance detection portion 66 outputs a sensor output signal V1 based on the infrared light reflected by the paper sheet P as shown in FIG. 9. The distance calculation portion 83 calculates a distance L1 based on a point P1 present on a straight line V=C₀/L shown in FIG. 9 that corresponds to the sensor output signal V1 by using the distance calculation formula V=C/L and the constant C₀. Here, to describe the distance calculation by using the graph shown in FIG. 9, the coordinate axes X and Y for the formula (3) L=C/V are replaced with each other to represent V=C/L.

If the temperature inside the image forming apparatus 1 increases, and if the ambient temperature around the distance detection portion 66 also rises, in the temperature characteristic of the distance detection portion 66 as shown in FIG. 10, the temperature rises and the sensor output V decreases to the contrary. For example, as shown by broken lines in FIG. 10, the sensor output V drops linearly substantially 0.1 V in a temperature range of 5° C. to 65° C. The drop amounts Δl, Δm, and Δs for a long distance (Ll), an intermediate distance (Lm), and a short distance (Ls) are the same. In other words, as the temperature changes, the constant C in the formula V=C/L changes. This means that as shown by the graph in FIG. 9, the gradient of the straight line represented by the formula V=C/L does not change but the straight line shifts vertically in parallel. For example, although the constant C of the distance detection portion 66 is stored in the ROM 77 as C₀ and the distance calculation formula is set to V=C₀/L at normal temperature in the time of production, if the ambient temperature increases from normal temperature in the time of image formation, the formula V=C/L shifts under the distance calculation formula V=C₀/L like the distance calculation formula V=Ct/L shown in FIG. 9.

Specifically, if the temperature detection portion 81 detects the predetermined temperature or higher, the distance detection portion 66 detects the predetermined distance to the calibration plate 85 before the paper sheet P is conveyed. Here, if the sensor output form the distance detection portion 66 is Vc, the calibration calculation portion 82 receives the sensor output signal Vc and the actual distance L₀ (the actual distance to the calibration plate 85) from the storage portion 75, calculates the constant C in the distance calculation formula V=C/L based on the sensor output signal Vc and the actual distance L₀, outputs C=Ct to the distance calculation portion 83 as the calibration data, thus the distance calculation formula V=Ct/L shown in FIG. 9 is obtained. In FIG. 9, the sensor output V₀ at the time the predetermined distance (actual distance L0) to the calibration plate 85 is measured in the time of production is also represented.

When the paper sheet P is conveyed, the distance calculation portion 83 measures the distance to the conveyed paper sheet P. Here, if the sensor output from the distance detection portion 66 is V2, the distance calculation portion 83 receives the sensor output V2 as second data, and calculates a distance L2 based on a point P2 that is present on the distance calculation formula V=Ct/L and corresponds to the sensor output signal V2 as shown in FIG. 9 by using the calibration data Ct received from the calibration calculation portion 82 and the distance calculation formula V=C/L. Thus, it is possible to correct the measurement result that is measured by the distance detection portion 66 at a high temperature.

### Second Embodiment

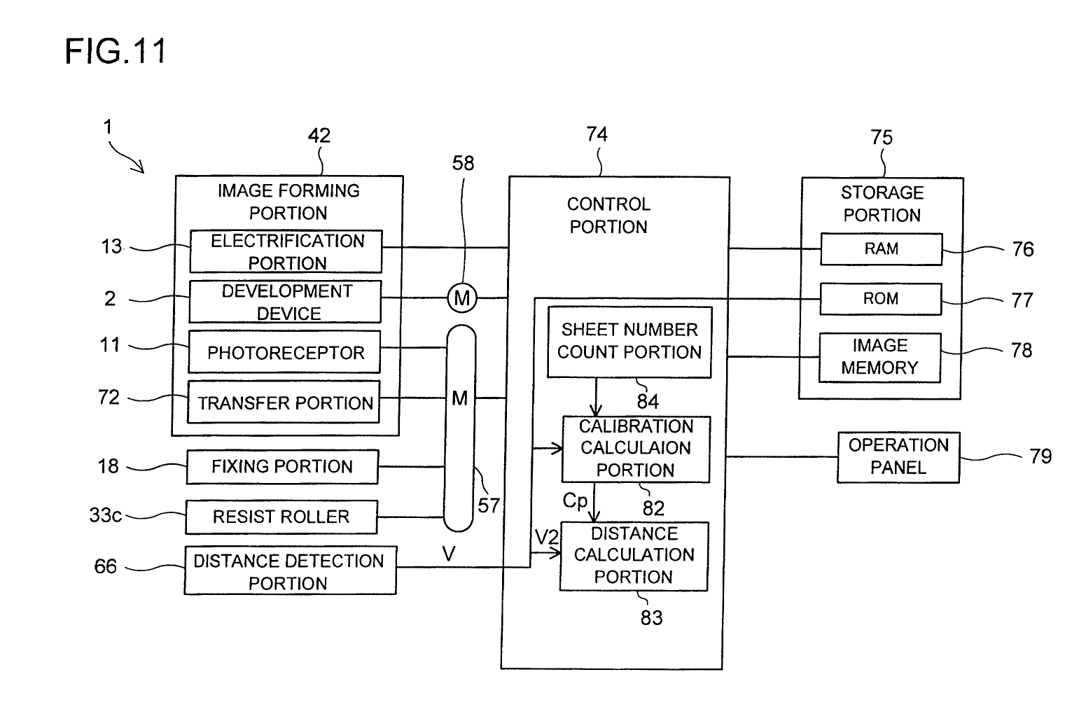

FIG. 11 is a block diagram showing a structure of an image forming apparatus according to a second embodiment of the present invention. A structure which is different from the first embodiment is chiefly explained, in which based on the number of paper sheets used for printing, calibration data are prepared and a distance is calculated; the explanation of the same parts as those in the first embodiment is skipped.

As shown in FIG. 11, the control portion 74 includes a sheet number count portion 84. If the number of paper sheets for printing is set on the operation portion of the operation panel 79 by a user, the sheet number count portion 84 counts the number of paper sheets used for printing since the time of production and shipment. As the number of paper sheets used for printing increases, the light amount from a light emitting portion decreases because of the time-dependent change of the distance detection portion 66, and the sensor output drops because of the decrease in the light amount from the distance detection portion 66. Like the temperature increase in the first embodiment, the sensor output drops linearly as the number of paper sheets used for printing increases.

The ROM 77 stores the actual distance Lo (the initial data) from the distance detection portion 66 to the calibration plate 85 that is adjusted at the time of production and the constant C₀.

If the sheet number count portion 84 counts the predetermined number of paper sheet or more, the distance detection portion 66 detects the predetermined distance to the calibration plate 85 before the paper sheet P is conveyed. Here, if the sensor output form the distance detection portion 66 is Vc, the calibration calculation portion 82 receives the sensor output signal Vc and the actual distance L₀ from the storage portion 75, calculates the constant C in the distance calculation formula V=C/L based on the sensor output signal Vc and the actual distance L₀, and outputs C=Cp to the distance calculation portion 83 as the calibration data.

When the paper sheet P is conveyed, the distance calculation portion 83 measures the distance to the conveyed paper sheet P. Here, if the sensor output from the distance detection portion 66 is V2, the distance calculation portion 83 calculates the distance L2 by using the calibration data Cp and the distance calculation formula V=C/L. Thus, it is possible to correct the measurement result that is measured by the distance detection portion 66 when the predetermined number of paper sheets or more are conveyed.

According to the embodiment above, the image forming apparatus 1 includes: the paper sheet conveying portion 65 that conveys the paper sheet P; the distance detection portion 66 that projects light to the paper sheet P, receives the reflected light from the paper sheet P, and measures the distance to the paper sheet P; and the storage portion 75 which when the distance detection portion 66 measures the distance to the predetermined position, stores the distance as the actual distance L₀ (the initial data). Besides, the image forming apparatus 1 includes; the calibration calculation portion 82 which before image formation, calculates the constant Ct or Cp (the calibration data) based on the sensor output signal Vc (the first data) that is received from the distance detection portion 66 when the distance to the predetermined position is measured and on the actual distance L₀ received from the storage portion 75; and the distance calculation portion 83 which in the time of image formation, based on the constant Ct or Cp (the calibration data), corrects the sensor output signal V2 (the second data) that is received from the distance detection portion 66 when the distance to the conveyed paper sheet P is measured and calculates a distance.

According to this structure, the projected light from the distance detection portion 66 is reflected by the paper sheet P, the reflected light is received by the distance detection portion 66, and the distance to the paper sheet P is detected based on the reflected light received by the distance detection portion 66. Thus, the bend amount of the paper sheet P is measured without touching the paper sheet P, and any portions such as the center portion and end portions of the paper sheet P are able to be used as portions to be measured; there is no constraint on the dispositions of the distance detection portion 66 and the like, and the paper sheet P and the toner image on the paper sheet P are not damaged. Besides, the sensor output V2 (the second data) for the distance to the paper sheet P in the time of image formation is corrected based on the constant Ct or Cp (the calibration data) that are calculated by using the actual distance L₀ (the initial data) in the time of production and shipment and on the sensor output signal Vc (the first data) used to measure the distance to the predetermined position immediately before the image formation, thereby fluctuations in the measurement at the distance detection portion 66 due to temperature change and time-dependent change are prevented from occurring, so that it is possible to stably measure the paper sheet conveying states irrespective of temperature change and time-dependent change of the distance detection portion 66.

According to the embodiment above, the distance detection portion 66 projects light to the paper sheet P through the opening 65a formed through a portion of the paper sheet conveying portion 65 and receives reflected light from the paper sheet P. To perform calibration, the distance detection portion 66 receives reflected light from the calibration surface that faces the paper sheet conveying path surface 65b of the paper sheet conveying portion 65. Specifically, the projected light from the distance detection portion 66 passes through the opening 65a of the paper sheet conveying portion 65, and reaches the paper sheet P or the calibration surface; the reflected light reflected by the conveyed paper sheet P or the calibration surface passes through the opening 65a and is received by the distance detection portion 66. Accordingly, the calibration surface is able to be easily formed and set by using a constituent member of the apparatus without using a special member. Besides, it is possible to set the calibration surface without disturbing the measurement of the distance to the conveyed paper sheet P.

In the second embodiment above, the structure is explained, in which the calibration data are prepared according to the number of paper sheets used for printing, and the calculated distance is corrected by using the calibration data. However, the present invention is not limited to this structure, and another structure may be employed, in which a job for printing successively a plurality of paper sheets is stored in the storage portion 75; for every predetermined number of paper sheets in the job, the calibration calculation portion 82 receives the sensor output Vc and the actual distance L₀ from the storage portion 75, calculates the calibration data by using the distance calculation formula V=C/L based on the sensor output signal Vc and the actual distance L₀, and outputs the calibration data to the distance calculation portion 83.

In the embodiment above, the structure is explained, in which the data such as the actual distance L₀, the constant C₀ and the like are stored into the ROM 77 in the time of production. However, the present invention is not limited to this structure, and another structure may be employed, in which the data such as the actual distance L₀, the constant C₀ and the like are remeasured in the time maintenance or repair of the image forming apparatus 1 is performed; the number of paper sheets for printing is reset to 0; and these data are stored into an erasable and writable storage device such as EPROM and the like.

In the embodiment above, the structure is explained, in which the calibration plate 85 is attached to a constituent member of the image forming apparatus 1. However, the present invention is not limited to this structure, and another structure may be employed, in which a surface of a constituent member is disposed at a predetermined distance; and the surface is so formed as to have the substantially same reflectance as that of the paper sheet P to be measured. Besides, another structure may be employed, in which if the reflectances are different from each other, the corrected values of the reflectances are stored into the storage portion 75 and the reflectance is corrected by using the corrected reflectances.

In the embodiment above, the example is explained, in which the paper sheet conveying portion 65 is disposed in the conveying path that conveys the paper sheet P between the transfer portion 41 and the fixing portion 18. However, the present invention is not limited to this structure, and the paper sheet conveying portion 65 may be disposed in the conveying path between the paper sheet supply cassette 32 and the transfer portion 41 or in another conveying path. Besides, the paper sheet conveying portion 65 may be disposed in a structure where the paper sheet conveying path is disposed in a horizontal direction of the apparatus and the distance detection portion 66 is disposed under the paper sheet conveying path. In this structure, it is possible to prevent foreign matter such as dust and the like that appears in the paper sheet conveying path from dropping to the distance detection portion with the cover member that closes the opening of the paper sheet conveying portion.

The present invention is applicable to a paper sheet conveying apparatus that is used for a copying machine, a printer, a facsimile and a multi-function machine of them which use an electrophotographic system and to an image forming apparatus having the paper conveying apparatus, and more particularly, to a paper sheet conveying apparatus for detecting a paper sheet conveying state and to an image forming apparatus having the paper sheet conveying apparatus.

What is claimed is:

1. A paper sheet conveying apparatus, comprising:
a paper sheet conveying portion that conveys a paper sheet and has an opening;
a distance detection portion that projects light to a paper sheet through the opening, receives reflected light from the paper sheet, and detects a distance to the paper sheet; and
a cover member that has a light projecting area portion which transmits the projected light therethrough, a light receiving area portion which transmits the reflected light therethrough, and a light block portion which is disposed between the light projecting area portion and the light receiving area portion and blocks flare light reflected by the light projecting area portion, wherein the cover member is disposed at a predetermined distance from a conveying path surface of the paper sheet conveying portion over the same side with respect to the distance detection portion.

2. The paper sheet conveying apparatus according to claim 1, wherein an opposite surface opposite to the conveying path surface of the paper sheet conveying portion is formed flat and the cover member is mounted on the opposite surface.

3. The paper sheet conveying apparatus according to claim 1, wherein the light block portion is formed of a wall that is treated black.

4. The paper sheet conveying apparatus according to claim 1, wherein the distance detection portion is disposed substantially under the paper sheet conveying portion.

5. The paper sheet conveying apparatus according to claim 1, wherein the paper sheet conveying portion and the distance detection portion are disposed in an open/close frame that is able to be freely opened and closed with respect to the apparatus.

6. The paper sheet conveying apparatus according to claim 1, wherein the cover member is fixed to and held by the paper sheet conveying portion with a cover hold member that pushes circumferential ends of the cover member to the paper sheet conveying portion.

7. A paper sheet conveying apparatus, comprising:
a paper sheet conveying portion that conveys a paper sheet;
a distance detection portion that projects light to a conveyed paper sheet, receives reflected light from the paper sheet, and measures a distance to the paper sheet;
a storage portion which when the distance detection portion measures a distance to a predetermined position, stores the distance as initial data;
a calibration calculation portion which before image formation, calculates calibration data based on first data that are received from the distance detection portion when the distance to the predetermined position is measured and on the initial data received from the storage portion; and
a distance calculation portion which in a time of image formation, based on the calibration data, corrects second data that are received from the distance detection portion when the distance to the conveyed paper sheet is measured and calculates a distance.

8. The paper sheet conveying apparatus according to claim 7, further comprising a temperature detection portion that detects temperature inside the apparatus, wherein if the temperature detection portion detects a predetermined temperature or higher, the calibration calculation portion sends the calculated calibration data to the distance calculation portion.

9. The paper sheet conveying apparatus according to claim 7, further comprising a sheet number count portion that counts the number of printed paper sheets, wherein if the sheet number count portion counts a predetermined number of printed paper sheets, the calibration calculation portion sends the calculated calibration data to the distance calculation portion.

10. The paper sheet conveying apparatus according to claim 7, wherein the storage portion stores a job that is set and executed, wherein if the storage portion stores a job for using a plurality of paper sheets for successive printing, the calibration calculation portion sends the calculated calibration data to the distance calculation portion for every predetermined number of paper sheets in the job.

11. The paper sheet conveying apparatus according to claim 7, wherein the distance detection portion projects light to a paper sheet through an opening formed through a portion of the paper sheet conveying portion and receives reflected light from the paper sheet; and a calibration surface that faces the conveying path surface of the paper sheet conveying portion is disposed at the predetermined position.

12. The paper sheet conveying apparatus according to claim 11, wherein the calibration surface has the substantially same reflectance as that of the paper sheet to be measured.

13. The paper sheet conveying apparatus according to claim 11, wherein the calibration surface is formed on a plate member that is attached to a member that constitutes the apparatus.

14. An image forming apparatus, comprising: the paper sheet conveying apparatus according to one of claims 1 and 7, wherein the paper sheet conveying portion conveys a paper sheet between a transfer portion that transfers a toner image formed on a photoreceptor to the paper sheet and a fixing portion that melts and fixes the toner image transferred to the paper sheet.
